(19) United States
(12) Patent Application Publication
(10) Pub. No.: US 2025/0043462 A1
(43) Pub. Date: Feb. 6, 2025

(54) INSECT REPELLENT POLYETHYLENE TEREPHTHALATE FIBERS

(71) Applicant: The Government of the United States of America, as represented by the Secretary of the Navy, Arlington, VA (US)

(72) Inventors: Jeffrey G. Lundin, Burke, VA (US); Ashley C. Fulton, Alexandria, VA (US); Matthew D. Thum, Annapolis, MD (US); James E. Cilek, Jacksonville, FL (US)

(73) Assignee: The Government of the United States of America, as represented by the Secretary of the Navy, Arlington, VA (US)

(21) Appl. No.: 18/791,989

(22) Filed: Aug. 1, 2024

Related U.S. Application Data
(60) Provisional application No. 63/516,984, filed on Aug. 1, 2023.

(51) Int. Cl. D01F 1/10; A01N 25/10; A01N 25/34; A01N 37/18; A01N 43/40; A01P 17/00; D01D 1/02; D01D 5/00; D01F 6/62; D04H 1/435; D04H 1/728

(52) U.S. Cl. CPC D01F 1/10; A01N 25/10; A01N 25/34; A01N 37/18; A01N 43/40; A01P 17/00; D01D 1/02; D01D 5/0038; D01F 6/62; D04H 1/435; D04H 1/728; D10B 2331/04

(57) ABSTRACT

An insect repellent material made from recycled polyethylene terephthalate and an insect repellent or from polyethylene terephthalate, N,N-diethyl-meta-toluamide, and picaridin. The material may be in the form of a fiber spun from a solution of the recycled polyethylene terephthalate and the insect repellent.

### REFERENCE TO RELATED APPLICATIONS

This application claims the benefit of U.S. Provisional Application No. 63/516,984, filed on Aug. 1, 2023. The provisional application and all other publications and patent documents referred to throughout this nonprovisional application are incorporated herein by reference.

### TECHNICAL FIELD

The present disclosure is generally related to insect repellent fibers.

### DESCRIPTION OF THE RELATED ART

Mosquitos are considered one of the world's deadliest creatures causing over 700,000 deaths per year as vectors for which deadly diseases such as Zika, malaria, and West Nile can spread.^{1, 2} Over a billion animals and humans are infected yearly, with malaria as the most common mosquito-borne disease. In 2021, approximately 247 million people were infected with malaria, which caused 619,000 deaths.³ Elimination of malaria and other mosquito-borne diseases requires preventative measures to stop transmission. The World Health Organization provides insecticides-treated mosquito nets and indoor insecticide spraying for the homes of people countries heavily impacted by malaria.³ However, outdoor environmental protection is regulated to topical treatment directly to the skin, such as insect repellent sprays and creams.⁴ These measures are effective, but concerns of skin permeation⁵ as well as water pollution⁶ brings about a need for an indirect way of protection.

Common commercially available synthetic based insect repellents contain N,N-diethyl-meta-toluamide (DEET) or icaridin (picaridin).⁷ The EPA also recognizes IR3535 and oil of lemon eucalyptus as biopesticides used as natural-based repellents.⁸ Topical repellents allow for mobile protection, but require reapplication for extended protection. For example, picaridin is a volatile compound with an estimated half-life of 5 hours at a concentration of 25%.⁹ Repellent sprays generally work in the vapor phase through evaporation based on vapor pressure and temperature. DEET is a multi-modal repellent, repelling through olfactory avoidance, contact, and ingestion.¹⁰ The vapor barrier of picaridin disrupts the insect's olfactory sense and taste preventing contact.¹¹ Encapsulation of repellents have shown to enable the extended release of repellents.12, 13 For example, solid lipid nanoparticles (SLN) have a high capacity of repellent loading but requires direct contact with the skin.¹⁴ Polymer-based encapsulations have proven most effective while limiting contact with the skin. The release rate of these systems depend on diffusion from the polymer matrix.¹⁵ Polymeric microcapsules consist of insect repellent encased in a spherical polymer sheath. Kadam and coworkers synthesized polyurethane microcapsules with DEET that had a significant reduction in the release rate of DEET.¹⁶ Synthesis of polymeric fibers containing insect repellent have been accomplished through extrusion¹⁷ and melt spinning.¹⁸ However, electrospinning provides a facile and quick method to identify formulations of fibers for the extended release of repellents.

Electrospinning polymer materials have been effective in drug delivery⁹, and extending the release of repellents^{20,21}. The synthesized fibers can quickly be tested for the composition as well as release of repellents. Monofilament nylon nanofibers was shown to have extended release of DEET with calculated half-life as high as 70 h.²⁰ Picaridin has also been utilized in the synthesis of fibers and was observed to have extended release of the repellent.²¹ There is a wide range of materials used in electrospinning. Munoz and coworkers synthesized cellulose-based nanofibrous mats for insect repellent activity²² using the biorepellent citriodiol. Biodegradable electrospun nanofibers have also been fabricated from poly(_{L}-lactic acid) (PLLA) with incorporation of DEET.²³ Reuse of a material has promise in the study of insect repellent-doped fibers.

Polyethylene terephthalate (PET) is a class of polyesters widely used in the food and beverage industry.²⁴ The polymer material provides shiny, rigid packaging that can be produced at a low cost. As a result, the food and beverage industry uses PET to package many single-use products. Unfortunately, the increased use of PET has become an escalating environmental problem.²⁵ The United States generates the largest amount of plastic waste in the world at 44 metric ton produced in 2019.²⁶ Recycling PET bottles provides a solution to an environmental problem while also being cost effective.²⁷

### SUMMARY OF THE INVENTION

Disclosed herein is a composition comprising: recycled polyethylene terephthalate; and an insect repellent.

Also disclosed herein is a method comprising: dissolving recycled polyethylene terephthalate in a solvent to form a solution; adding an insect repellent to the solution; and removing the solvent from the solution.

Also disclosed herein is a composition comprising: polyethylene terephthalate, N,N-diethyl-meta-toluamide, and picaridin.

Also disclosed herein is a method comprising: dissolving polyethylene terephthalate in a solvent to form a solution; adding N,N-diethyl-meta-toluamide and picaridin to the solution; and removing the solvent from the solution.

### BRIEF DESCRIPTION OF DRAWINGS

A more complete appreciation will be readily obtained by reference to the following Description of the Example Embodiments and the accompanying drawings.

FIG. 1 shows a diagram of bioassay using live insects.

FIG. 2 shows fiber diameters of monofilament rPET fibers in a box plot where dots represent the individual measurements.

FIGS. 3A-D show scanning electron microscope (SEM) images of electrospun rPET microfibers with (FIG. 3A) no repellent loading, (FIG. 3B) 50 wt % Picaridin, (FIG. 3C) 50 wt % DEET (FIG. 3D) 54 wt % DEET/Picaridin.

FIGS. 4A-C show thermogravimetric analysis (TGA) heating ramps showing the mass loss of repellent from fibers containing (FIG. 4A) 0-70 wt % DEET (FIG. 4B) 0-50 wt % picaridin and (FIG. 4C) 0-54 wt % DEET/Picaridin blend.

FIG. 5 shows ATR-FTIR of electrospun microfibers from electrospun microfibers rPET, rPET-50-D, rPET-50-P, rPET-54-DP, neat DEET and picaridin composites showing the full spectrum (top) and the area of interest (bottom).

FIG. 6 shows the isothermal release profile of rPET with 54 wt % DEET/picaridin microfibers at 60, 80, 100° C.

FIG. 7 shows the linear fit for the Arrhenius analysis used to determine the activation energy of rPET with 54 wt % DEET/picaridin electrospun microfibers. Error bars are a result of triplicate measure.

FIG. 8 shows live insect testing of rPET, rPET-50-P, rPET-50-D and rPET-54-DP electrospun nonwoven microfiber mats. The study was conducted for 3 weeks with testing at 0 h, 24 h, 1 week, 2 weeks, and 3 weeks. An 8 h evaluation was conducted at each testing time with repellency observations at 10 min, 15 min, 30 min, 1 h, 2 h, 3 h, 4 h, 5 h, 5 h, 6 h, 7 h, and 8 h. The plot represents the distribution of repellency at each testing time. Yellow line represents 50% repellency (no repellent activity).

FIG. 9 shows a calculated HSP plot. Left sphere is of PET and right sphere is of nylon. The blue dots represent DEET, DEET/Picaridin and picaridin. Repellents are within the sphere of PET indicating good affinity to the polymer.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein are polymer fibers from recycled polyethylene terephthalate (rPET) loaded with dual insect repellents (DEET and picaridin) for long-term insect repellent applications. The purpose is to repel biting arthropods (insects, ticks, etc.) for multiple weeks. The material can exist in various forms such as yarns, patches, fabrics etc. as appropriate for the desired application. The system is composed of linear polymer and insect repellent with high loading of insect repellent. The fibers are formed through dissolution of polymer and insect repellent followed by an electrospinning method, resulting in facile fabric

Herein is shown the use of recycled PET (rPET) from commercial drink bottles as a polymer feedstock for functional long-term release insect repellent microfibers. Fiber morphology and size were identified by scanning electron microscopy (SEM). Repellent retention in the electrospun fibers were tested using thermogravimetric analysis (TGA). Release kinetics of the repellents from the fibers was calculated based on isothermal TGA experiments. A live mosquito bioassay was used to evaluate the repellency of the electrospun PET fibers for 3 weeks. Repellency was observed in all fibers tested with the highest repellency observed at 100% for over one week. The method provides DEET-loaded PET microfibers that exhibit extended mosquito repellency that significantly outperforms current commercially available repellent products.

The disclosed composition comprises recycled polyethylene terephthalate and an insect repellent. The polyethylene terephthalate may be sourced from beverage bottles, for example. The insect repellent may be, for example, a combination of N,N-diethyl-meta-toluamide and picaridin. The composition may comprise at least 10 wt % of the insect repellent relative to the polyethylene terephthalate.

Alternatively, a composition may be made from any polyethylene terephthalate and a combination of DEET and picaridin.

The composition may be made by dissolving the recycled polyethylene terephthalate in a solvent to form a solution, adding an insect repellent to the solution, and removing the solvent from the solution. These steps as stated herein may include dissolving the polyethylene terephthalate and the insect repellent at the same time. Suitable solvents may include, for example, trifluoroacetic acid and methylene chloride. One example way to remove the solvent is to form a fiber by electrospinning. The electrospun fibers may be formed into a mat.

The following examples are given to illustrate specific applications. These specific examples are not intended to limit the scope of the disclosure in this application.

Materials—Polyethylene terephthalate (PET) was recycled from plastic soft drink bottles obtained from Coca Cola and Pepsi Companies. The bottles were rinsed thoroughly first with distilled water, then methanol (Sigma-Aldrich, 99% purity), and allowed to dry. Trifluoroacetic acid (TFA) and methylene chloride (DCM, HPLC grade) were purchased from Fischer Scientific and used as received. N,N,-diethyl-meta-toluamide (DEET) was provided by TCI America, and 1-(1-methylpropoxycarbonyl)-2-(2-hydroxyethyl)piperidine (picaridin) was purchased from MedChemExpress (Monmouth Junction, NJ).

Electrospinning monofilament fibers—Solutions of rPET were prepared by cutting the drinking bottles into 1×1 cm pieces. A mixture of 30% TFA and 70% DCM by weight was made. The rPET pieces were added to the solution at 10 rel. wt % concentration. DEET, picaridin or a mixture of 1 to 1 DEET/picaridin was added to the rPET solution to achieve the desired concentration with respect to rPET (0, 10, 15, 30, 40, 50, 54, 60, 70 wt %), Table 1. Solutions were sealed and mixed for 24 h at 20° C. to obtain complete homogenous mixtures. For mixtures containing 60 and 70 wt % DEET, heating at 60° C. overnight (18 h) was required. After dissolution, solutions were stored at 2-4° C. and warmed to room temperature before use.

TABLE 1
List of sample abbreviations

| Abbreviation | Definition |
|---|---|
| rPET | 10 wt % recycled PET microfibers |
| rPET-10-D | rPET with 10 wt % DEET |
| rPET-30-D | rPET with 30 wt % DEET |
| rPET-50-D | rPET with 50 wt % DEET |
| rPET-60-D | rPET with 60 wt % DEET |
| rPET-70-D | rPET with 70 wt % DEET |
| rPET-40-P | rPET with 40 wt % Picaridin |
| rPET-50-P | rPET with 50 wt % Picaridin |
| rPET-15-DP | rPET with 15 wt % of 1:1 DEET/Picaridin |
| rPET-40-DP | rPET with 40 wt % of 1:1 DEET/Picaridin |
| rPET-54-DP | rPET with 54 wt % of 1:1 DEET/Picaridin |

Monofilament fibers were fabricated through electrospinning on a custom-built system. The polymer solutions were loaded into a 10 mL syringe equipped with a 22-gauge needle. A New Era Pump Systems syringe pump (NE-300) was used to dispense the solution horizontally toward a grounded collector. The needle was set at a distance of 12 cm from grounded collector. Accelerating voltage was set to 12 kV by a Bertan Series 205B high voltage power supply. Fibers were collected onto aluminum foil as nonwoven mats. For live insect testing, fibers were collected for 45 min. onto a 10×10 in. metal wire screen. All nonwoven mats were evaluated following 24 h residence at room temperature (18° C.) to afford solvent removal.

Characterization—The morphology of electrospun monofilament fibers was characterized by field emission scanning electron microscope (SEM) on a JEOL JSM-7600F (Peabody, MA). Operating voltage was set to 5 kV. Samples were sputter coated with at least 3 nm of gold prior to SEM analysis using a Cressington 108 auto sputter coater equipped with a MTM20 thickness controller. Fiber thickness was determined using ImageJ software (n≥100).

Analysis of release kinetics and fiber composition was ascertained by thermogravimetric analysis (TGA) on a TA Instrument Discovery TGA using platinum pans (100 μL). Thermal decomposition was evaluated by heating ramps performed at a heating rate of 10° C./min to 600° C. Kinetic measurements were deduced from isothermal decay curves performed in a nitrogen atmosphere at 60, 80, and 100° C. for 300 min. Isothermal curves were fit to nonlinear decay models using Origin software. Rate constants obtained from the nonlinear decay models were used in the Arrhenius rate equation to determine release rate of fibers at 20° C., as well as half-life and activation energy.

Compositional analysis of electrospun nanofibers was evaluated using an attenuated total reflectance-Fourier transform infrared (ATR-FTIR) spectrometer from Thermo Scientific (Nicolet iS50-FTIR spectrometer) equipped with an iS50 ATR attachment and Ge crystal. Background and sample spectra consisted of 128 scans averaged together with 4 cm⁻¹ resolution at a scanner velocity of 10 KHz.

Headspace analysis and method—To detect the volatile organic compounds (VOCs) in the headspace of rPET/DEET/picaridin fibers, a 7890B/5977B Agilent GC-MS coupled with the 7697A Agilent Headspace Sampler (Agilent Technologies, Santa Clara, CA) was used for analysis. The GC-MS was equipped with a 30 m×0.25 mm i.d.×0.25 mm, Rxi-5 MS column (Restek, Bellefonte, PA). The sample subjected to headspace analysis was rPET-54-DP monofilament fibers produced via electrospinning. Approximately 2 mg of fibers were prepared, rolled into a ball, and placed into a 20 mL Agilent headspace vial equipped with a crimp cap. The fibers were allowed to sit at room temperature (22° C.±3°) for 2 h. Prior to headspace extraction, the vial was allowed to equilibrate at 90° C. for 25 min while shaking at 50 shakes/min in the headspace sampler, and then followed by 30 s injection to the injection loop set at 90° C. The sample was transferred to GC-MS via transfer line set to 100° C. The analytes flowed at a rate of 20 mL/min. The GC column oven began at 40° C., was held for 30 s, increased to 250° C. at 40° C./min, and finally held at 250° C. for 1 min. The mass scan range m/z 40-300 and the transfer line to the MS was 250° C.

Hansen Solubility Parameters (HSP)—Diffusion kinetics between polymer and substrate were quantifiably interpreted through Hansen Solubility Parameters (HSPs) analysis. HSPiP software obtained from Hansen-Solubility website (https://www.hansen-solubility.com/HSPiP/) was used to perform the analysis.

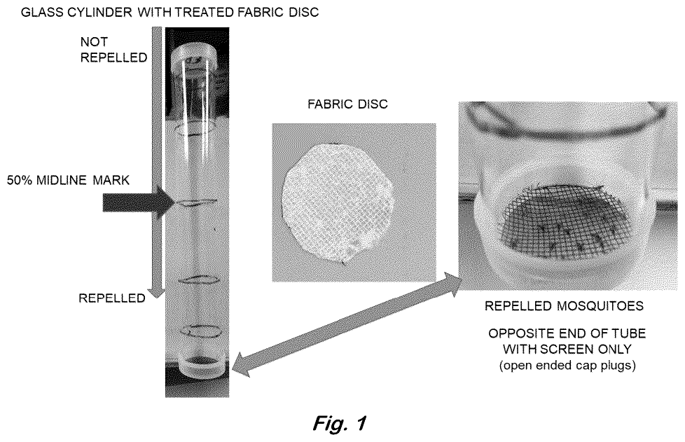

Biological assay method—Evaluation of repellent-loaded microfibers was conducted using an adapted bioassay method developed by Jiang and coworkers.²⁸ Solutions containing 10 wt % rPET with 0 wt % repellent, 50 wt % DEET, 50 wt % picaridin or 54 wt % DEET/picaridin blend were electrospun into nonwoven mats on a wire screen. A 4.5 cm diameter hole punch with a surface area of 15.9 cm² was used to remove standardized disc samples from each textile for testing. Three samples were removed from each textile mat. Each excised disc was then separately placed into an open-ended 4.5 diameter×1.0 cm translucent polyethylene end cap (SF-16, Caplugs, Buffalo, NY) and placed over one end of a 3.8 diameter by 30.5 cm clear glass cylinder (FIG. 1). Three-to-five-day-old insecticide-susceptible female Aedes aegypti (ORL strain) were used in all evaluations. An average of 15 non-blood fed mosquitoes were then mouth aspirated into each cylinder. Once mosquitoes were introduced into each tube, a similar sized metal 1×1.2 mm mesh window screen disc with endcap was placed on the opposite end to prevent escape of mosquitoes and provide ventilation. Initially, all cylinders were positioned horizontally on a table until the start of testing. Once mosquitoes were transferred to all tubes, they were positioned at a 45° incline with the textile disc at the top of the cylinder.²⁹ Controls consisted of rPET, as well as the metal window screen the latter used as a negative control. Samples were stored in a freezer (−18° C.) until testing and allowed to warm to room temperature (22° C.) for 15 min before testing. Testing started at approximately 0700 with data recorded at 10, 15, 30 min, then hourly through 8 h of continuous exposure in tubes. Mosquitoes located on or beyond the midline of the tube were scored as repelled.²⁸ To determine residual effectiveness of treatments, testing was conducted at 0, 24 h, and weekly intervals thereafter for 3 wks. Between evaluation intervals, all discs were stored in separate clear plastic polyethylene bags at ambient room temperature in a windowless laboratory under continuous overhead lighting. Room temperature and relative humidity were recorded with a ThermoPro TP49 digital meter at the time of tests. Results are presented as mean (±SE) percent of mosquitoes≥50% from repellent source.

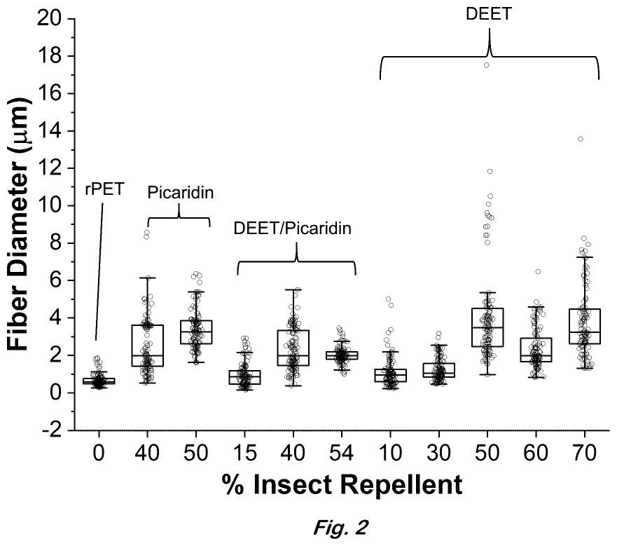

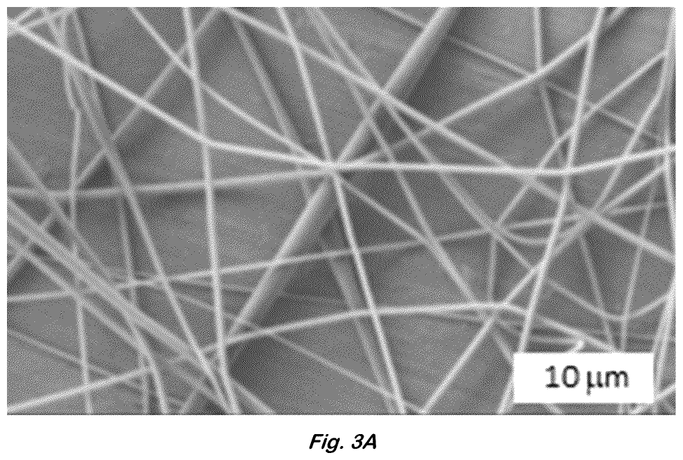

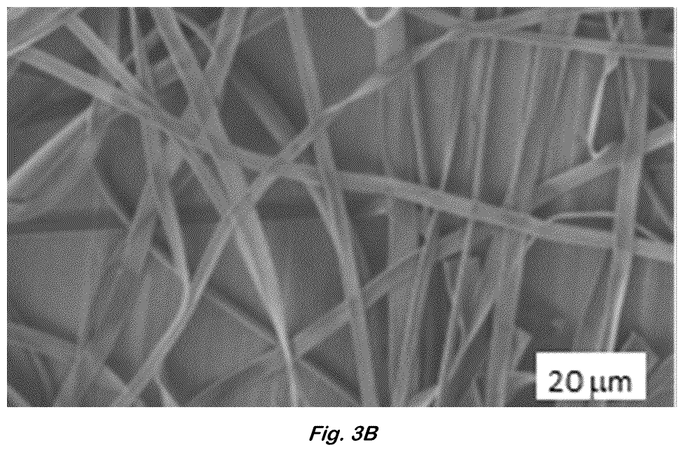

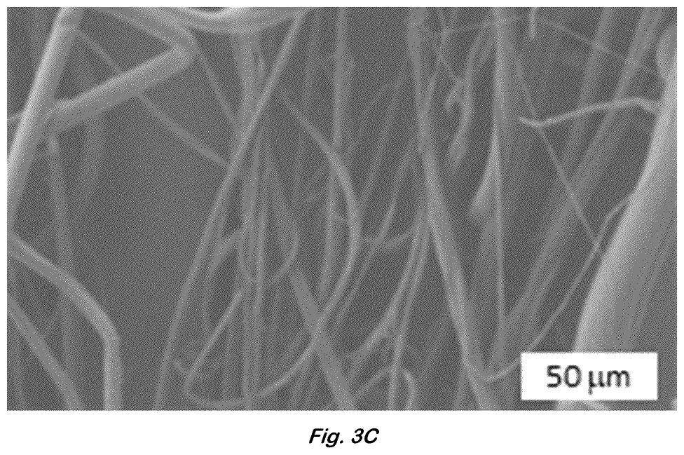

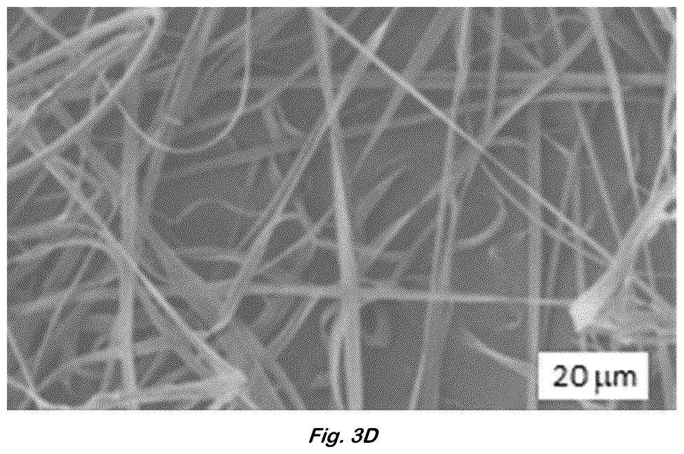

Characterization of monofilament microfibers—Electrospun microfibers at 10 wt % rPET loaded with 10-70 wt % repellents were synthesized using method discussed above. Repellents used were DEET, picaridin, and a 1:1 mixture of DEET and picaridin. The effects of repellent concentration relative to the PET on fiber diameter and morphology were evaluated with SEM. Fiber diameter varied greatly for all fibers synthesized as seen in FIG. 2. Previous studies with repellent loaded nylon fibers produced nanofibers (100-500 nm)^{20, 21}, while recycled PET allowed for microfibers (0.6-4.0 μm) to be obtained. Fiber morphology was dependent on insect repellent type, combination, and conservation. Common morphologies observed were cylindrical, ribbon-like, beading, branching, and loops. Cylindrical shape is normal morphology for fibers. Ribbon-like shape occurs when fiber diameter reaches its capacity and the structure collapses on itself.³⁰ The imbalance of surface tension and electrical forces can also affect the shape of the fiber. This instability results in the ejecting of a smaller fiber from the primary fiber in what is called branching. This splitting can also result in loops where the smaller branched fibers spin upon themselves forming a larger segmented fiber. When the electrical forces are reduced the surface tension forces fluid into the beads.³¹ Recycled PET fibers containing no repellents were cylindrical and free from defects (FIG. 2). DEET fibers contained a mixture of morphologies. Both cylindrical and ribbon fibers occurred in all DEET-loaded fibers tested. Morphological defects increased with increasing DEET loading. Branches and loops were prevalent in fibers containing 50 and 60 wt % DEET. Beading as well as branching occurs in 70 wt % DEET fibers. Picaridin fibers contained ribbon-like morphology with some branching. Fibers containing a blend of repellents had ribbon-like and cylindrical fibers at 15 wt % with branching. When repellent loading increased to 40 and 54 wt % only the ribbon-like morphology was observed.

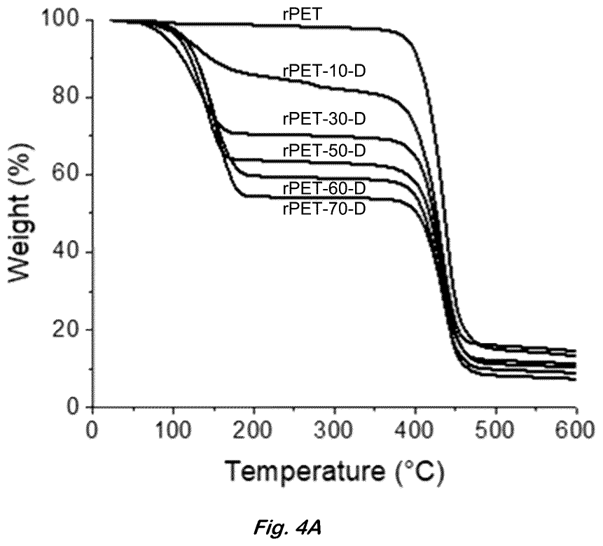

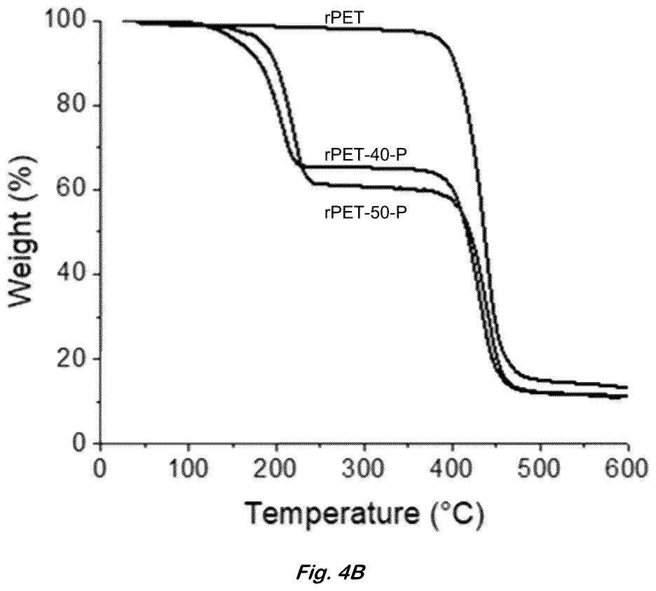

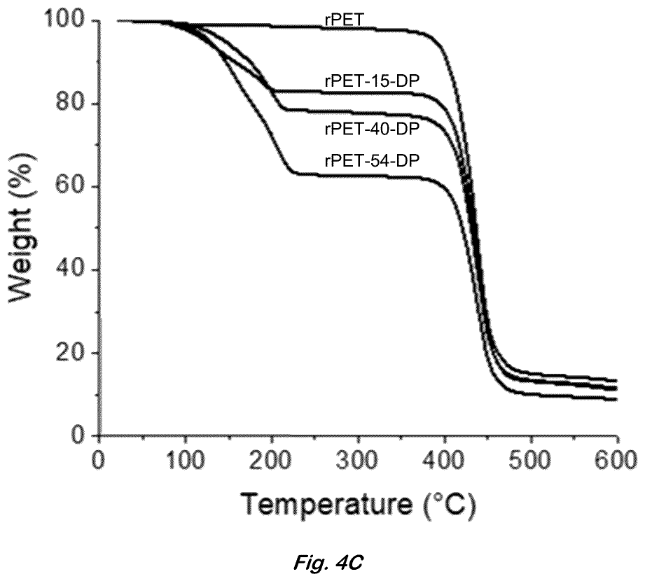

The amount of insect repellent retained in the electrospun fibers was determined using TGA. Fibers were subjected to increasing temperature from room temperature to 600° C. at 10° C./min to evaluate the mass loss within the ramp (FIGS. 4A-B). The decrease in fiber mass at 250° C. was attributed to loss of insect repellent, from which the percentage of repellent retained was calculated.²⁰ After electrospinning, DEET rPET fibers retained 80.0-97.5% of DEET form the initial electrospinning solution (Table 2). Picaridin rPET fibers retained nearly all (97.5%) after electrospinning. The greater retention of picaridin than DEET in rPET electrospun fibers was attributed to the lower vapor pressure of picaridin. Repellent retention in DEET/picaridin rPET fibers ranged from 54.1% to 87.2%. The use of dual-repellents causes an increase of evaporation during electrospinning. Headspace analysis was performed using GC/MS to determine analytes present during evaporation at room temperature.

TABLE 2
Retention rates of rPET electrospun microfibers

| Sample | Retention (wt %) |
|---|---|
| rPET | — |
| rPET-10-D | 80.0 |
| rPET-30-D | 97.5 |
| rPET-50-D | 88.0 |
| rPET-60-D | 89.1 |
| rPET-70-D | 94.0 |
| rPET-40-P | 97.5 |
| rPET-50-P | 97.6 |
| rPET-15-DP | 79.7 |
| rPET-40-DP | 54.1 |
| rPET-54-DP | 87.2 |

Headspace analysis was performed on rPET-54-DP fibers to identify the relative rates of release. The headspace of a neat DEET and picaridin blend was first evaluated as a standard to identify the GC peaks that correspond to each repellent. DEET and 2-butanol were preliminarily identified from the DEET/picaridin standard mixture, in addition to siloxane containing compounds attributed to column decay. 2-Butanol is a known fragment of picaridin³² and the most abundant in the headspace. The headspace of rPET-54-DP was tested at 2 h, 1 day, and 7 days. Again, 2-butanol and DEET were two major compounds within the headspace throughout the study. Significantly, trifluoroacetic acid and DCM were not identified in the headspace, thus indicating no residual solvent in the rPET-54-DP fibers.

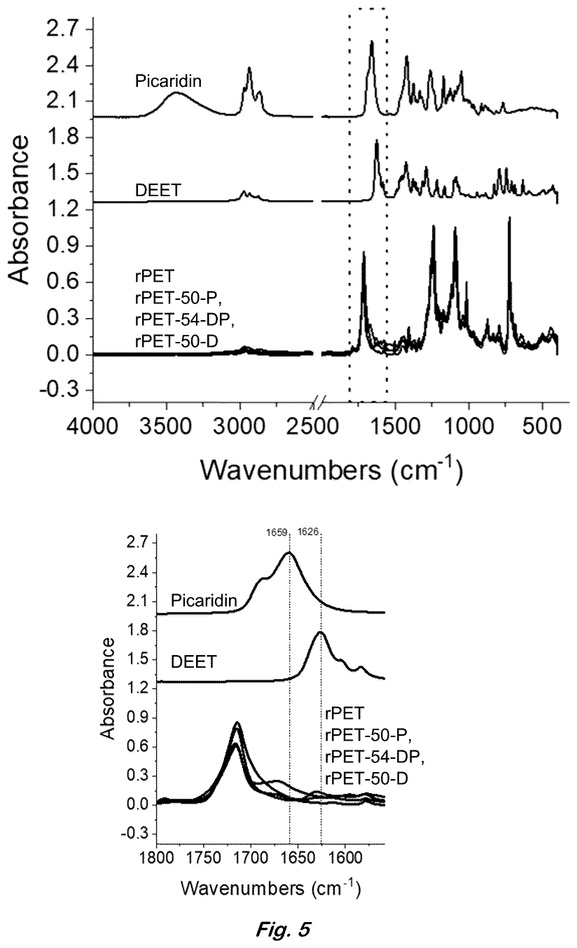

FTIR was used to determine the composition of the rPET fibers. Fibers from solutions containing rPET with 0 wt % repellent, 50 wt % DEET, 50 wt % picaridin and 54 wt % DEET/picaridin were evaluated using ATR-FTIR (FIG. 5). The characteristic bands of PET occurred in all fibers at 2978 and 2852 cm⁻¹ (C—H stretching), 1715 cm⁻¹ (C—O stretching of carboxylic ester group), 1581, 1506, and 1409 cm⁻¹ (C—C aromatic stretching), 1453 and 870 cm⁻¹ (CH₂ bending and rocking), sharp peaks at 1238 and 1090 cm⁻¹ (C—C—O stretching of ester group), sharp peaks at 1015 and 723 cm⁻¹ (in-plane C—H stretching and out-of-plane C—H bending of aromatic ring).³³ In the insect repellent loaded fibers, peaks corresponding to repellents were observed and confirmed incorporation of IRs, however most peaks associated with the repellents overlap with rPET peaks due to the structural similarities. Notably, the sharp C═O stretch at 1626 cm⁻¹ associated with DEET shifted slightly higher wavenumber to 1630 cm⁻¹ in rPET-50-D fibers suggesting potential intermolecular interactions between rPET and DEET, similar to behavior previously observed in PLLA-DEET fibers.²³ This behavior is also observed in rPET-50-P fibers, the sharp peak at 1659 cm⁻¹ from the hydrogen bonded carbamate carbonyl (C═O) stretch associated with picaridin shifted to 1670 cm⁻¹. Additionally, lack of shifts in the repellent peaks in rPET fibers suggests physical entrapment of repellent within the polymer matrix.

Repellent release kinetics of monofilament microfibers—Measuring repellent release rate kinetics and calculations of repellent lifetime is an important factor to elucidate to understand compositional effects on release and predict future repellent performance. Isothermal TGA experiments were conducted at 60, 80, and 100° C. to determine the release rate of repellents. The specific temperatures (60, 80, and 100° C.) were selected to accelerate material screening to downselect for bioassay evaluation, and to provide sufficient release to confidently fit release curves to calculate estimated release kinetics at ambient temperature. Each experiment was maintained for 5 h where the mass loss over time was attributed to the evaporation of repellent. The data was fit to a first order reaction model (Equation 1) to calculate the rate constant (k) at each temperature. Where y is the mass percent remaining of the sample for a given temperature at time, t. A is defined as a pre-exponential factor, k, is the rate constant in s⁻¹, and c is a constant for fitting purposes.

$$y = A \times {e}^{- kt} + c \qquad ( 1 )$$

The rate constant was then used to calculate the activation energy (Ea) using the linearized Arrhenius equation (Equation 2). Where k is the calculated rate constant, R, is the universal gas constant (8.314 J/mol·K), and T is the temperature in Kelvin. The ln(k) was plotted against their given temperatures and the generated slope was used to calculate the activation energy.

$$ln ( k ) = \frac{- {E}_{a}}{R} ( \frac{1}{T} ) + ln ( A ) \qquad ( 2 )$$

The half-life was also calculated at using Equation (3).

$${T}_{1 / 2} = 0.693 / k \qquad ( 3 )$$

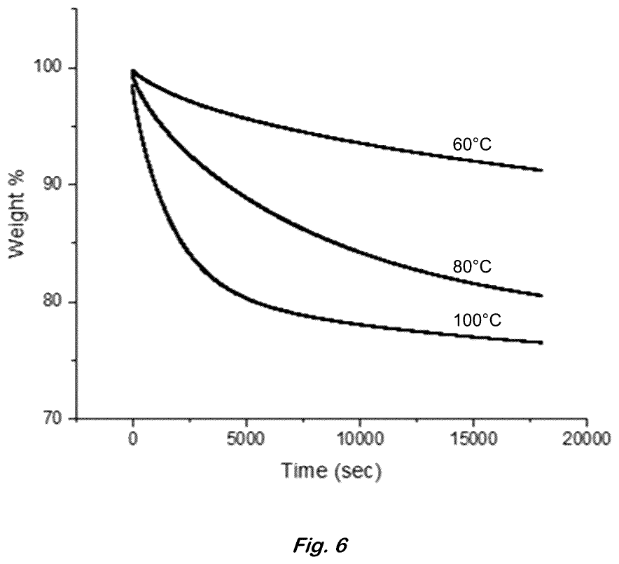

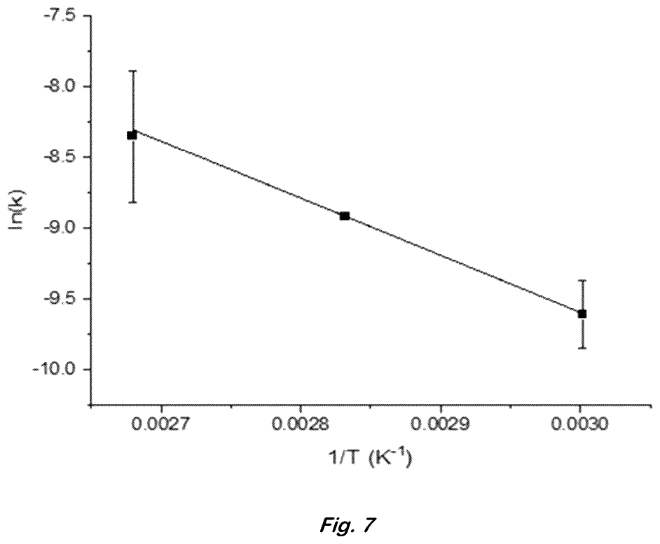

The release profiles of rPET-50-D, rPET-50-P, and rPET-55-DP were evaluated. FIG. 6 displays the profile of 54 wt % DEET/picaridin 1:1 blend. Expectedly, the rate at which repellent evaporates increases with increasing temperature (FIG. 6). A plot of the ln(k) vs. the inverse temperatures (FIG. 7) gave a linear fit line, which was used to calculate Eₐ using Equation 2. From this, the rate constant at for hypothetical 20° C. was calculated and was used in Equation 3 to determine the half-life of each sample at room temperature. Identifying fiber performance at 20° C. was imperative due to high mosquito activity at ambient temperatures.³⁴ Activation energy, rate constant, and half-life of samples tested are displayed in Table 3.

TABLE 3
Activation energy, rate constant, and half-life
of repellents at 20° C. from electrospun
microfibers. Errors indicate a triplicate measurement

| | | | t_{1/2} (h), |
|---|---|---|---|
| Repellent | Eₐ (kJ/mol) | k (s⁻¹), at 20° C. | at 20° C. |
| rPET-50-D | 85.4 ± 17.6 | 3.53 × 10⁻⁷ ± 1.03 × 10⁻⁶ | 545.8 ± 160 |
| rPET-55-DP | 33.5 ± 10.7 | 1.30 × 10⁻⁵ ± 2.74 × 10⁻⁵ | 14.8 ± 7.0 |

The activity of each repellent differed greatly. The release model used was not effective for picaridin fibers. The Eₐ of rPET-50-P was determined to be 17.4±17.6 kJ/mol, due to this uncertainty the rate constant and half-life were not calculated. The rate constant for the loss of repellent at 20° C. ranged from 3.53× 10⁻⁷ to 1.3×10⁻⁵ s⁻¹ with the repellent blend having the highest and DEET having the lowest rate of release. This also translated to activation energy and half-life. The DEET/picaridin rPET fibers resulted in an activation energy of 33.5 kJ/mol and half-life of 14.8 h. DEET rPET fibers were calculated to have an activation energy of 85.4 kJ/mol and a significantly long half-life of 545.8 h (22.7 days). This is a significant increase in half-life compared to the previous study of DEET loaded nylon 6,6 fibers²⁰, indicating potential positive intermolecular interactions between DEET and rPET to effectively slow the release of DEET. The calculated release kinetics of the fibers were compared to actual performance using live insect testing.

Repellent activity of electrospun fibers—Fibrous rPET mats were subjected to a novel bioassay to evaluate their efficacy for live mosquito repellency over multiple weeks. This bioassay was specifically designed to evaluate the long-term repellent efficacy of insect repellent-loaded fibers and textiles, and this represents the first report of the use of this bioassay in the evaluation of insect repellent-loaded materials. Additionally, this is the first use of a live mosquito bioassay to evaluate the of repellent-doped electrospun microfibers. rPET nonwoven mats were first evaluated over a 24 h span during continuous exposure to identify the role of insect repellent composition on repellency and validate the bioassay method. Furthermore, this study aimed to identify possible synergistic effects from the combination of DEET and picaridin in the same fibers system. Separate mosquito populations were exposed to rPET, rPET-50-D, rPET-50-P, and rPET-54-DP nonwoven mats. The percent repellency was determined as the percentage of mosquitoes on the opposite half of the test tube. It is expected that if a material exhibited no repellent effect, then the mosquitos would be uniformly distributed throughout the tube thus resulting in a % repellency value of 50%, as probability dictates at any time period half of the mosquitoes would be in one half of the tube. Expectedly, the rPET exhibited an average distribution in the range of 40% to nearly 50%, which clearly represents no repellency in the unmodified fiber. Incorporation of picaridin in rPET fibers resulted in only minor improvement over the control at some time points, but was mostly statistically similar to the control. Both rPET-50-D and rPET-54-DP fibers demonstrated very high repellency immediately within 90% range and both maintained approximately 100% repellency through 24 h. Commercial insect repellent sprays exhibit repellency on the order of several hours.¹⁰ Since both rPET-50-D and rPET-54-DP fibers exhibited near 100% repellency over the full 24 h, potential synergistic effects were not able to be resolved from this study. Further evaluation of the fibers was performed to identify the entire duration of effective repellency of the insect repellent loaded rPET fibers.

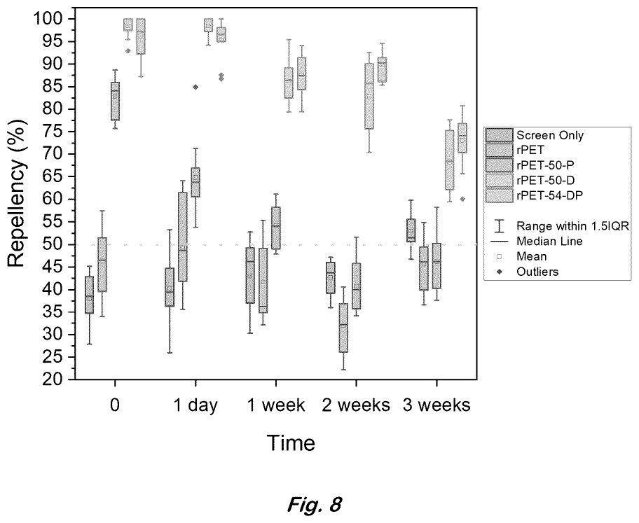

A three-week study was conducted on the rPET fibers to determine the effects of long-term aging on repellent performance. The performance of rPET, rPET-50-P, rPET-50-D, rPET-54-DP, and a blank metal screen are shown in FIG. 8. The average initial masses of fibrous mats subjected to the bioassay were 0.029±0.002, 0.020±0.010, and 0.0372±0.0035 g, for rPET-50-D, rPET-50-P, and rPET-54-DP, respectively, which resulted in the respective repellent areal densities of 0.541±0.038, 0.402±0.206, and 0.715±0.068 mg/cm². The blank metal screen was incorporated as a negative control to confirm the behavior of the mosquitoes and further validate the test method. The range of insect behavior from the screen was approximately 50% at the midline for the entire 3-week duration, which serves as a negative control to validate that the test method does not bias for repellency or non-repellency. The rPET control also demonstrated close to 50% at the midline over 3 weeks, similar to that of the screen alone, indicating that the unmodified rPET does not exhibit any insect repellent effect. The initial repellency of rPET-50-P was approximately 85% and the repellency decreased steadily until reaching no repellency range at week 1, suggesting lack of intermolecular interaction between repellent and polymer. The rPET-50-D fibers exhibited 100% repellency through hour 8 in the 24 h testing and at 1 week remained at approximately 85%. At 3 weeks, rPET-50-D fibers still exhibited some repellency of 60-75%, which was greater than that of the controls. However, by week 1 the variability of rPET-50-D increased significantly. The rPET-54-DP fibers demonstrated long-term repellent efficacy over 2-3 weeks, with nearly 100% repellency up to hour 8 in the 24 h testing. Significantly, rPET-54-DP fibers maintained an approximate 90% repellency through weeks 1 and 2, representing long-term repellency, and rPET-54-DP fibers repellency was still within the 80% range at 3 weeks. Long-term repellency was achieved at concentrations comparable to 0.8 mg/cm² DEET spray that has shown to result in 8 h of protection.¹⁰ Although the role of synergistic effects on repellent efficacy are unclear, repellency variability decreased in fibers containing both repellents. Notably, there is a benefit to dual repellent loading in the polymer matrix.

Quantified interpretation of diffusion kinetics by HSP analysis and proposed physical model—Hansen Solubility Parameters (HSPs) have demonstrated quantified relationships on the issue of solubility, dispersion, diffusion, and more through its direct correlation with chemical affinity.³⁵⁻³⁸ Hansen solubility parameters are a tri-component position where δd, δp, and δh are the dispersion, polar, and hydrogen bonding parameters, respectively.³⁴ As the distance between two coordinates (Ra) in “Hansen space” decreases, the chemical affinity between those two chemicals or mixtures increases.³⁶ Polymers exhibit an inherent interaction radius (Ro) wherein solvents or solvent mixtures within or on this radius (Ra/Ro≤1) will dissolve or swell the polymer. If Ra/Ro>1, the solvent or solvent mixture will exhibit no chemical affinity to the polymer. This Ra/Ro ratio is also called the Relative Energy Difference (RED) value.³⁸

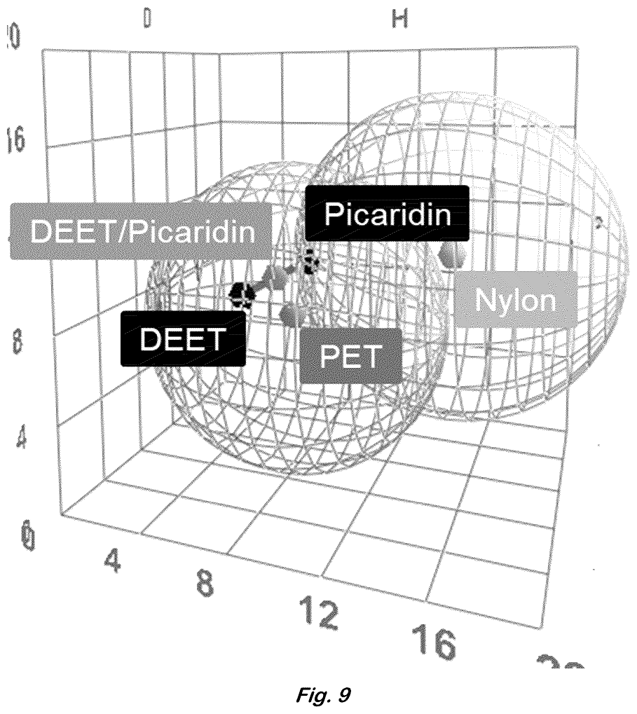

The RED PET values in Table 4 show DEET, picaridin and 1:1 DEET/Picaridin blends exhibiting a RED PET value≤1. Nylon 6,6 in contrast only exhibits a RED value≤1 with picaridin. This indicates a higher chemical affinity between PET and the insect repellents as all reside within the inherent interaction radius in Hansen space (FIG. 9) and with smaller RED values. The 1:1 DEET/picaridin exhibits a lower RED PET value than the individual insect repellents alone. This higher chemical affinity can aid in the retention of insect repellents within the polymer matrix, therefore, resulting in the distinctly longer repellency in live mosquito testing as observed in the 1:1 DEET/Picaridin fibers. This correlation is consistent with previous studies of electrospun nylon 6,6 loaded with DEET in which DEET-Nylon fibers exhibited a shorter half-life relative to DEET-PET fibers.²⁰ The RED value for nylon and DEET indicated no chemical affinity between polymer and insect repellent as DEET resides outside of the inherent interaction radius in Hansen space (FIG. 9).

TABLE 4
Hansen solubility parameters used to calculate the RED values
for PET and nylon 6,6. Where δd, δp, and δh are
the dispersion, polar, and hydrogen bonding Ro is the radius.

| | δd | δp | δh | | | RED |
|---|---|---|---|---|---|---|
| Sample | (MPa^{1/2}) | (MPa^{1/2}) | (MPa^{1/2}) | Ro | RED PET | Nylon 6,6 |
| PET | 18.2 | 6.4 | 6.6 | 8.0 | — | — |
| Nylon 6,6 | 17.4 | 9.9 | 14.6 | 8.0 | — | — |
| DEET | 18.1 | 7.1 | 3.6 | — | 0.39 | 1.43 |
| Picaridin | 17.3 | 8.9 | 6.8 | — | 0.39 | 0.99 |
| DEET/Picaridin | 17.7 | 8.0 | 5.3 | — | 0.30 | 1.19 |

Based on the HSP analysis and IR analysis, a physical interpretation is proposed of the insect repellent loading in PET and the molecular interactions dictating release behavior. Strong intermolecular interaction between DEET-PET resulting from the polar interactions from the carbonyl, amide, and ester, as well as pi-pi interactions of aromatic rings in each compound are responsible for the high retention of DEET and the extended-release profile. In fibers containing DEET, the combination of polar-polar and aromatic interactions facilitated the dispersion of DEET throughout the PET matrix. Furthermore, the polar and pi-intermolecular interactions contributed an energetic barrier, over which the DEET had to overcome to volatilize, resulting in extended-release profiles and long-term repellent release. In picaridin-PET fibers, the polar contributions were weaker and the aromatic component absent, thus the release of picaridin-PET was not significantly improved compared to neat picaridin. The dual-repellent-loaded fibers demonstrated additive behavior of the independent DEET and picaridin interactions, thus resulting in an intermediate release profile where the improvement was attributed to DEET-PET interactions. Ultimately, the live insect release behavior was primarily dependent on the amount of repellent that remained in the PET fibers at any given time and, therefore, the intermolecular interactions between the repellent and polymer matrix, as predicted with HSPs, represent and effective approach to design and modulate the release profile and live insect release performance in IR-loaded polymer fibers.

Microfibers composed of recycled PET consumer bottles and EPA-registered insect repellents were fabricated via electrospinning. Characterization of the fibers indicated entrapment to the repellents within the polymer that allows for the extended release of the repellent via diffusion. Morphology and fiber thickness varied throughout all fibers. However, it did not interfere with the retention of repellents after electrospinning with retention rates up to 97%. Repellent rate constants and half-life was calculates using isothermal TGA experiments at room temperature. It was shown that rPET fibers with 50 wt % DEET exhibit significantly long release times with a half-life nearly 23 days. Nonwoven mats containing repellents were tested against live mosquitoes initially over a 24 h period where 100% repellency was observed with 50 wt % DEET and 54 wt % DEET/picaridin fibers. Further study on the performance of the fibers as they aged was conducted. Again, 50 wt % DEET and 54 wt % DEET/picaridin fibers continued to repel above the controlled environments throughout the 3-week study. The repellent blend showed higher performance with precision of repellency. Investigation of the solvent interactions of repellents and polymer strongly correlate the performance with the chemical affinity. The repellent blend was calculated to have highest chemical affinity to rPET allowing for extended diffusion of the repellents thus longer repellency. Commercially available repellent sprays can maintain their repellency up to 10 h for DEET and 8 h for picaridin before reapplication.39 This method allows for repellency beyond 3 weeks as the study indicates continued repellency of 80% at 3 weeks for fibers containing 1:1 DEET/picaridin blend. As such, the IR loaded-PET fibers described herein represented a novel fiber-based long-term insect repellent platform for potential patch, yarn feedstock, or textile applications. Future work will focus on the durability of the fibers through laundering, as well as transition to the extrusion of fibers for manufacturing of textiles and fabrics.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

### REFERENCES

(1) Fighting the World's Deadliest Animal | CDC. www.cdc.gov. https://www.cdc.gov/globalhealth/stories/2019/world-deadliest-animal.html#print (accessed 2022 Nov. 22).
(2) Breedlove, B. Deadly, Dangerous, and Decorative Creatures. Emerging Infectious Diseases 2022, 28 (2), 495. https://doi.org/10.3201/eid2802.ac2802.
(3) World Malaria Report 2022; World Health Organization: https://www.who.int/teams/global-malaria-programme/reports/world-malaria-report-2022, 2022.
(4) Jadhav, S.; Sirdesai, A.; Bandyopadhyay, Dr. P. Assessment of Comparative Bio-Efficacy of Mosquito Repellent Cream and Liquid Mosquito Repellent Vaporizers. International Journal of Mosquito Research 2022, 9 (6), 44-46. https://doi.org/10.22271/23487941.2022.v9.i6a.640.
(5) Dos Santos, J.; Lino Lourenço, R.; Rosa, P.; Adams, A. I. H. Evaluation of Quality and Safety Parameters of DEET Commercial Repellents: Photostability, Penetration/Permeation and Eye Irritation Studies. Drug Analytical Research 2022, 6 (1), 21-26. https://doi.org/10.22456/2527-2616.124882.
(6) Jiang, J.; Gong, Y.; An, Z.; Li, M.-X.; Huo, Y.; Zhou, Y.; Jin, Z.; Xic, J.; He, M. Theoretical Investigation on Degradation of DEET by ·OH in Aqueous Solution: Mechanism, Kinetics, Process Optimization and Toxicity Evaluation. Journal of Cleaner Production 2022, 362, 132260-132260. https://doi.org/10.1016/j.jclepro.2022.132260.
(7) Strid, A.; Hanson, W.; Cross, A.; Bond, C.; Jenkins, J. Insect Repellents. National Pesticide Information Center, Oregon State University Extension Services. http://npic.orst.cdu/factsheets/repellents.html (accessed 2022 Jan. 18).
(8) CDC. Prevent Mosquito Bites. CDC. https://www.cdc.gov/zika/prevention/prevent-mosquito-bites.html (accessed 2023 Jan. 23).
(9) Goodyer, L.; Schofield, S. Mosquito Repellents for the Traveller: Does Picaridin Provide Longer Protection than DEET? Journal of Travel Medicine 2018, 25 (Suppl_1), S10-S15. https://doi.org/10.1093/jtm/tay005.
(10) Dennis, E. J.; Goldman, O. V.; Vosshall, L. B. Aedes Aegypti Mosquitoes Use Their Legs to Sense DEET on Contact. Current Biology 2019, 29 (9), 1551-1556. https://doi.org/10.1016/j.cub.2019.04.004.
(11) Elsayed, G. A.; Hassabo, A. G. Insect Repellent of Cellulosic Fabrics (a Review). Letters in Applied NanoBioScience 2021, 11 (1), 3181-3190. https://doi.org/10.33263/lianbs111.31813190.
(12) Mapossa, A. B.; Focke, W. W.; Tewo, R. K.; Androsch, R.; Kruger, T. Mosquito-Repellent Controlled-Release Formulations for Fighting Infectious Diseases. Malaria Journal 2021, 20 (1). https://doi.org/10.1186/s12936-021-03681-7.
(13) Shah, S. I.; Khutoryanskiy, V. V.; Williams, A. C. A Novel Polymer Insect Repellent Conjugate for Extended Release and Decreased Skin Permeation of Para-Menthane-3,8-Diol. Pharmaceutics 2021, 13 (3), 403. https://doi.org/10.3390/pharmaceutics13030403.
(14) İşcan, Y.; Hekimoglu, S.; Sargon, M. F.; Hincal, A. A. DEET-Loaded Solid Lipid Particles for Skin Delivery: in VitroRelease and Skin Permeation Characteristics in Different Vehicles. Journal of Microencapsulation 2006, 23 (3), 315-327. https://doi.org/10.1080/02652040500444198.
(15) Borandch, S.; van Bochove, B.; Teotia, A.; Seppälä, J. Polymeric drug delivery systems by additive manufacturing. Advanced drug delivery reviews 2021, 173, 349-373. https://doi.org/10.1016/j.addr.2021.03.022.
(16) Kadam, S. A.; Yadav, P.; Bhutkar, S.; Patil, V. A.; Shukla, P. G.; Shanmuganathan, K. Sustained Release Insect Repellent Microcapsules Using Modified Cellulose Nanofibers (MCNF) as Pickering Emulsifier. Colloids and Surfaces A: Physicochemical and Engineering Aspects 2019, 582, 123883-123883. https://doi.org/10.1016/j.colsurfa.2019.123883.
(17) Maia, J. N.; La Corte, R.; Martínez, J.; Ubbink, J. B.; Prata, A. S. Improved Activity of Thyme Essential Oil (Thymus vulgaris) against Aedes Aegypti Larvae Using a Biodegradable Controlled Release System. Industrial Crops and Products 2019, 136, 110-120. https://doi.org/10.1016/j.indcrop.2019.03.040.
(18) Mayibongwe Sibanda, M.; Focke, W. W.; Braack, L.; Leuteritz, A.; Brünig, H.; Tran, N. H.; Wieczorek, F.; Trumper, W. Bicomponent Fibres for Controlled Release of Volatile Mosquito Repellents. Materials Science and Engineering: C 2018, 91, 754-761. https://doi.org/10.1016/j.msec.2018.06.016.
(19) Zhang, J. Z.; Xiao, C.; Zhang, X.; Lin, Y.; Yang, H.; Zhang, Y.; Ding, J. An Oxidative Stress-Responsive Electrospun Polyester Membrane Capable of Releasing Anti-Bacterial and Anti-Inflammatory Agents for Postoperative Anti-Adhesion. Journal of Controlled Release 2021, 335, 359-368. https://doi.org/10.1016/j.jconrel.2021.04.017.
(20) Thum, M. D.; Weise, N. K.; Casalini, R.; Fulton, A. C.; Purdy, A. P.; Lundin, J. G. Incorporation of N,N,-Diethyl-Meta-Toluamide within Electrospun Nylon-6/6 Nanofibers. Journal of Applied Polymer Science 2022, 139 (48). https://doi.org/10.1002/app.53237.
(21) Ryan, J. J.; Casalini, R.; Orlicki, J. A.; Lundin, J. G. Controlled Release of the Insect Repellent Picaridin from Electrospun Nylon-6,6 Nanofibers. Polymers for Advanced Technologies 2020, 31 (12), 3039-3047. https://doi.org/10.1002/pat.5028.
(22) Muñoz, V.; Buffa, F. A.; Molinari, F. N.; Hermida, L. G.; García, J. A.; Abraham, G. A. Electrospun Ethylcellulose-Based Nanofibrous Mats with Insect-Repellent Activity. Materials Letters 2019, 253, 289-292. https://doi.org/10.1016/j.matlet.2019.06.091.
(23) Bonadies, I.; Longo, A.; Androsch, R.; Johnichen, D.; Göbel, M.; Di Lorenzo, M. L. Biodegradable Electrospun PLLA Fibers Containing the Mosquito-Repellent DEET. European Polymer Journal 2019, 113, 377-384. https://doi.org/10.1016/j.eurpolymj.2019.02.001.
(24) Bumbudsanpharoke, N.; Ko, S. Nanoclays in Food and Beverage Packaging. Journal of Nanomaterials 2019, 2019, 1-13. https://doi.org/10.1155/2019/8927167.
(25) Phelan, A. (Anya); Meissner, K.; Humphrey, J.; Ross, H. Plastic Pollution and Packaging: Corporate Commitments and Actions from the Food and Beverage Sector. Journal of Cleaner Production 2022, 331 (331), 129827. https://doi.org/10.1016/j.jclepro.2021.129827.
(26) Milbrandt, A.; Coney, K.; Badgett, A.; Beckham, G. T. Quantification and Evaluation of Plastic Waste in the United States. Resources, Conservation and Recycling 2022, 183, 106363. https://doi.org/10.1016/j.resconrec.2022.106363.
(27) Strain, I. N.; Wu, Q.; Pourrahimi, A. M.; Hedenqvist, M. S.; Olsson, R. T.; Andersson, R. L. Electrospinning of Recycled PET to Generate Tough Mesomorphic Fibre Membranes for Smoke Filtration. Journal of Materials Chemistry A 2014, 3 (4), 1632-1640. https://doi.org/10.1039/C4TA06191H.
(28) Jiang, S.; Yang, L.; Bloomquist, J. R. High-Throughput Screening Method for Evaluating Spatial Repellency and Vapour Toxicity to Mosquitoes. Medical and Veterinary Entomology 2019, 33 (3), 388-396. https://doi.org/10.1111/mve.12377.
(29) Owusu, H. F.; Müller, P. How Important Is the Angle of Tilt in the WHO Cone Bioassay? Malaria Journal 2016, 15 (1). https://doi.org/10.1186/s12936-016-1303-9.
(30) Koombhongse, S.; Liu, W.; Rencker, D. H. Flat Polymer Ribbons and Other Shapes by Electrospinning. Journal of Polymer Science Part B: Polymer Physics 2001, 39 (21), 2598-2606. https://doi.org/10.1002/polb.10015.
(31) Fong, H.; Reneker, D. H. Elastomeric Nanofibers of Styrene-Butadiene-Styrene Triblock Copolymer. Journal of Polymer Science Part B: Polymer Physics 1999, 37 (24), 3488-3493. https://doi.org/10.1002/(sici)1099-0488(19991215)37:24%3C3488::aid-polb9%3E3.0.co;2-m.
(32) Knepper, T. P. Analysis and Mass Spectrometric Characterization of the Insect Repellent Bayrepel and Its Main Metabolite Bayrepel-Acid. Journal of Chromatography A 2004, 1046 (1-2), 159-166. https://doi.org/10.1016/j.chroma.2004.06.067.
(33) Park, S.; Thanakkasarance, S.; Shin, H.; Lee, Y.; Tak, G.; Sco, J. PET/Bio-Based Terpolyester Blends with High Dimensional Thermal Stability. Polymers 2021, 13 (5), 728. https://doi.org/10.3390/polym13050728.
(34) Rowley, W. A.; Graham, C. L. The Effect of Temperature and Relative Humidity on the Flight Performance of Female Aedes Aegypti. Journal of Insect Physiology 1968, 14 (9), 1251-1257. https://doi.org/10.1016/0022-1910(68)90018-8.
(35) Hansen, C. M. Hansen solubility parameters: a user's handbook. (Boca Raton: CRC Press, [2007], 2007).
(36) Jimenez, J.; Ford, E. Mapping wet vs gel spinning in Hansen space. Polymer 2021, 230, 124079. https://doi.org:10.1016/j.polymer.2021.124079
(37) Lara, J.; Zimmermann, F.; Drolet, D.; Hansen, C. M.; Chollot, A.; Monta, N. The use of the Hansen solubility parameters in the selection of protective polymeric materials resistant to chemicals. International Journal of Current Research 2017, 9, 47860-47867. https://hal.science/hal-01639526.
(38) Jameel, B. M.; Huynh, A.; Chadha, A.; Pandey, S.; Duncan, J.; Chandler, M.; Baki, G. Computer-based formulation design and optimization using Hansen solubility parameters to enhance the delivery of ibuprofen through the skin. International Journal of Pharmaceutics 2019, 569, 118549. https://doi.org:https://doi.org/10.1016/j.ijpharm.2019.118549
(39) Tavares, M.; da Silva, M. R. M.; de Oliveira de Siqueira, L. B.; Rodrigues, R. A. S.; Bodjolle-d'Almeida, L.; dos Santos, E. P.; Ricci-Júnior, E. Trends in Insect Repellent Formulations: A Review. International Journal of Pharmaceutics 2018, 539 (1-2), 190-209. https://doi.org/10.1016/j.ijpharm.2018.01.046.

What is claimed is:

1. A composition comprising:
recycled polyethylene terephthalate; and
an insect repellent.

2. The composition of claim 1, wherein the insect repellent is a combination of N,N-diethyl-meta-toluamide and picaridin.

3. The composition of claim 1, wherein the composition comprises at least 10 wt % of the insect repellent relative to the polyethylene terephthalate.

4. The composition of claim 1, wherein the composition is in the form of an electrospun fiber.

5. A method comprising:
dissolving recycled polyethylene terephthalate in a solvent to form a solution;
adding an insect repellent to the solution; and
removing the solvent from the solution.

6. The method of claim 5, wherein the solution is electrospun to remove the solvent.

7. The method of claim 5, wherein the insect repellent is a combination of N,N-diethyl-meta-toluamide and picaridin.

8. The method of claim 5, wherein the solution comprises at least 10 wt % of the insect repellent relative to the polyethylene terephthalate.

9. A composition comprising:
polyethylene terephthalate;
N,N-diethyl-meta-toluamide; and
picaridin.

10. The composition of claim 9, wherein the composition comprises at least 10 wt % of the combined N, N-diethyl-meta-toluamide and picaridin relative to the polyethylene terephthalate.

11. The composition of claim 9, wherein the composition is in the form of an electrospun fiber.

12. A method comprising:
dissolving polyethylene terephthalate in a solvent to form a solution;
adding N,N-diethyl-meta-toluamide and picaridin to the solution; and
removing the solvent from the solution.

13. The method of claim 12, wherein the solution is electrospun to remove the solvent.

14. The method of claim 12, wherein the solution comprises at least 10 wt % of the combined N,N-diethyl-meta-toluamide and picaridin relative to the polyethylene terephthalate.
